(19) United States
(12) Patent Application Publication
(10) Pub. No.: US 2019/0056275 A1
(43) Pub. Date: Feb. 21, 2019

(54) Fiber Optic Thermometer

(71) Applicant: Vibrosound, Ltd., Mazor (IL)

(72) Inventors: Yuvi KAHANA, Rinatya (IL); Alexander KOTS, Ashdod (IL)

(21) Appl. No.: 16/058,775

(22) Filed: Aug. 8, 2018

(30) Foreign Application Priority Data
Aug. 17, 2017 (IL) 254056

(51) Int. Cl. G01K 11/18; G01K 1/14; G01K 5/52; G01K 11/32; G01D 5/26

(52) U.S. Cl. CPC G01K 11/18; G01K 1/14; G01D 5/268; G01K 11/3206; G01K 5/52

(57) ABSTRACT

A fiber optic thermometer has a hollow body made of material of low thermal expansion and an optical fiber supported by a high thermal expansion intermediate support to form a cantilever section, a fiber optic splitter coupled to a first end of the optical fiber and a light source for directing light into the optical fiber via one branch of the optical splitter. A photodetector receives light conveyed through the optical fiber via the other branch of the optical splitter and measures intensity of the received light. A reflective target supported at a second end of the hollow body is axially aligned with the second end of the optical fiber at room temperature. Upon ambient temperature changes the cantilever section moves relative to the reflective target thereby changing the instantaneous intensity of light reflected by the target into the second end of the optical fiber and measured by the photodetector.

### FIELD OF THE INVENTION

The present invention relates to fiber optic sensors, particularly to sensors substantially not affected by very strong electromagnetic fields and ionization radiation.

### BACKGROUND OF THE INVENTION

The group of sensors known as fiber optic thermometers generally refers to those devices measuring higher temperatures wherein blackbody radiation physics are utilized. Lower temperature targets—say from −100° C. to 400° C.—and to this group refers the present invention can be measured by activating various sensing materials such as phosphors, semiconductors or liquid crystals with fiber optic links offering the environmental and remoteness advantages. Examples of such sensors are disclosed in U.S. Pat. Nos. 8,170,382; 3,960,017; 4,669,872 in which the material having temperature dependent optical properties is fixed on the tip of the fiber. For example GaAs crystal will be transparent at a wavelength above 850 nm and the position of the band edge is temperature dependent and is shifted about 0.4 nm/Kelvin. The light is directed from the LED via the fiber optic splitter and the optical fiber to the crystal, where it is absorbed and partially reflected back into the fiber and via splitter is dispatched to a spectrometer. The spectrometer provides a spectrum with the position of the band edge, from which the temperature is calculated.

The disadvantages of such sensors are high cost because of complexity of their construction and using of the spectrometers as a signal conditioner and non-immunity to the ionization radiation that limits their use in nuclear power industry.

### SUMMARY OF THE INVENTION

It is therefore a broad object of the present invention to provide a fiber optic thermometer having a simpler construction and being low cost for both its production and use and immune to the ionization radiation.

According to an aspect of the present invention there is provided a fiber optic thermometer comprising:

a hollow body made of material of low thermal expansion,

an optical fiber having a first end and a second end remote from the first end, said optical fiber being supported toward the second end inside the hollow body so as to form a cantilever section,

a intermediate fiber support made of material of high thermal expansion,

a fiber optic splitter coupled to the first end of the optical fiber,

a light source for directing light into the optical fiber via a first branch of the optical splitter,

a photo detector arranged for receiving light conveyed through the optical fiber via a second branch of the optical splitter and measuring an intensity of the received light, and

a reflective target disposed within and supported at a second end of the hollow body so as to be axially aligned with the second end of the optical fiber;

whereby upon temperature change the cantilever section moves such that its position relative to the reflective target changes thereby changing the instantaneous intensity of light reflected by the target into the second end of the optical fiber and measured by the photo detector.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows schematically a fiber optic thermometer constructed and operating according to the present invention;

FIG. 2 shows schematically a partial cross-sectional view of the fiber optic thermometer depicted in FIG. 1 with the possibility to change the mounting point of an intermediate support in the thermometer body;

FIG. 3 is a schematic partial cross-sectional view of the fiber optic thermometer depicted in FIG. 1 with the filament made of material having high coefficient of thermal expansion as an intermediate support;

FIG. 4 shows schematically a partial cross-sectional view of the fiber optic thermometer depicted in FIG. 1 where the intermediate support is a part of the hollow body and reflective target is fixed on the support made of material of high thermal expansion; and

FIG. 5 shows schematically a partial cross-sectional view of the fiber optic thermometer depicted in FIG. 1 with sharp edge contact surface between intermediate support and the optical fiber.

### DETAILED DESCRIPTION OF EMBODIMENTS

With specific reference now to the figures in detail, it is stressed that the particulars shown are by the way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more details than necessary for fundamental understanding of the invention, the description taken with the drawings making apparent to those skilled in the art how the several forms of the invention may be embodied in practice.

In the following description of some embodiments, identical components that appear in more than one figure or that share similar functionality will be referenced by identical reference symbols.

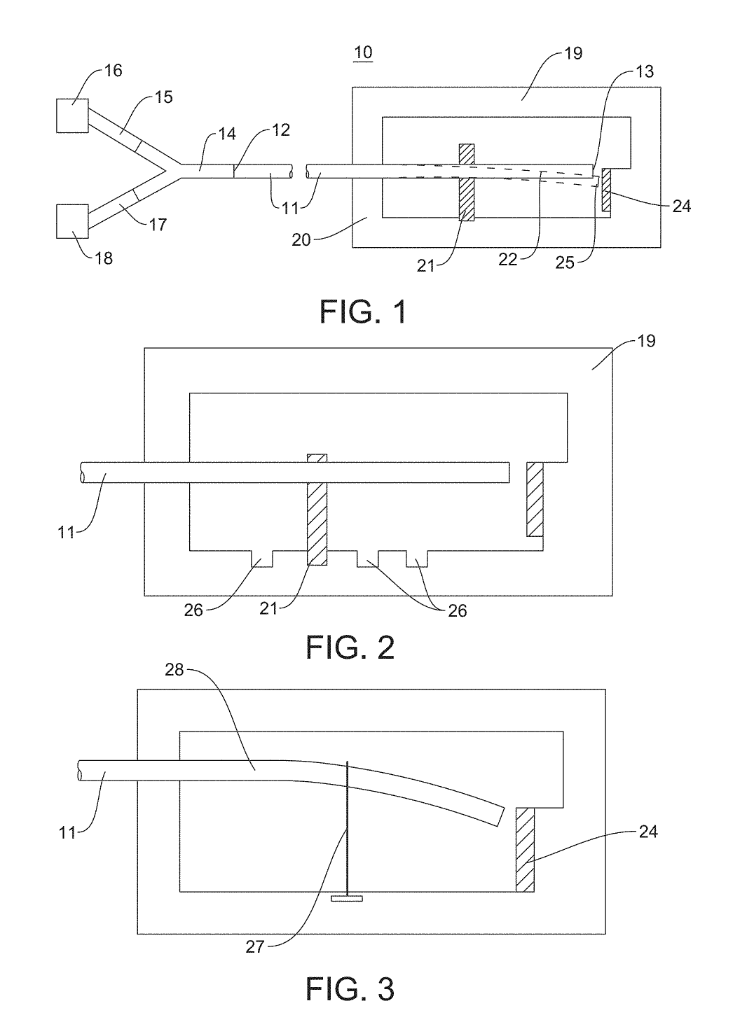

FIG. 1 is a schematic illustration of a fiber optic thermometer 10 constructed and operating according to present invention. The thermometer 10 includes an optical fiber 11 having a first end 12 constituting an input/output and a second end 13. The first end 12 is fixed to a fiber optic splitter 14, to a first branch of which is coupled a first fiber 15 having a light source 16 at its end and to whose second branch is coupled a second fiber 17 with a photo detector 18 at its end. The thermometer 10 has a generally hollow body portion 19 having an end wall 20 and intermediate support 21 through which the fiber 11 protrudes and by which it is supported so that toward the second end 13 of the fiber there is formed a short cantilever section 22. The span section 23 of the fiber 11 between wall 20 and intermediate support 21 is capable of deflection consequent to variation in height of intermediate support due to the ambient temperature change. The cantilever section 22 serves for the amplification of the displacement of the fiber end 13. The length of the optical fiber outside of the hollow body portion 19 may be kilometers in length. A reflective target 24 is affixed within the hollow body to an inside surface of an opposite end wall in axial alignment with the optical fiber when in its rest at room temperature.

Light from the light source 16 is conveyed through the optical fiber 15 via the first branch of the light splitter 14 to the optical fiber 11 whence it is directed to the second end 13. Light emitted from the free end 13 strikes the reflective target 24, which reflects a portion of the light back to the second end 13 of the optical fiber 11. The reflected light striking the second end 13 is conveyed through the optical fiber 11, via the second branch of the fiber optic splitter 14 and the fiber 17 into the photo detector 18, which measures the intensity of the reflected light.

According to the temperature changes the intermediate support 21 expands or shrinks and the second end 13 of the cantilever section 22 consequently moves up or down about its point of attachment and moves to an off-axis location 25, thus changing its position relative to the light reflective target 24. This means that the instantaneous intensity of the light conveyed by the free end of the optical fiber toward the target 24 is reduced or increased, as is the instantaneous intensity of the light reflected by the target 24 to the optical fiber. As a result, the intensity of light reaching the photo detector 18 changes according to the changes of the ambient temperature and the output signal of photo detector 18 changes as a function of the temperature variation.

FIG. 2 shows schematically a partial cross-sectional view of the thermometer 10 according to another embodiment wherein the length of the span 23 between hollow body wall 20 and the intermediate support 21 is adjustable. As in the previous embodiment, the optical fiber 11 is firmly fixed toward one end in the accelerometer body 19 and intermediate support 21 so as to form a cantilever section 22 serving as an amplification lever increasing displacement of the free end 13 relative to the body 19 and being configured to change its position relative to the reflective target 24 that is fixed opposite the free end 13 of the optical fiber 11 coaxially therewith. The target is illuminated by light 26 emanating from the moving second end 13 of the optical fiber. Light 26 is partially reflected back by the target 24 toward the free second end 13 and conveyed by the optical fiber via the second branch of the fiber optic splitter 14 and the fiber 17 into the photo detector 18. As the position of the free second end 13 changes relative to the target 24, the intensity of the light reflected back by the target 24 into the free second end 13 of the optical fiber changes accordingly. Changing the position of the intermediate support 21 to position 26 thereby can change the sensitivity and dynamic range of the thermometer 10. FIG. 3 is a schematic partial cross-sectional view of a fiber optic thermometer according to yet another embodiment where instead of a rigid intermediate support, a thin filament made of material having high coefficient of thermal expansion 27 is used. The movement of the free end of the fiber 13 in the case when the filament 27 elongates under increasing temperature is insured by flexibility of the fiber itself. To this end, the cantilever section of the fiber 28 is bent in advance so that the free end of the fiber 13 takes a neutral position relative to the reflective target 24 at a room temperature.

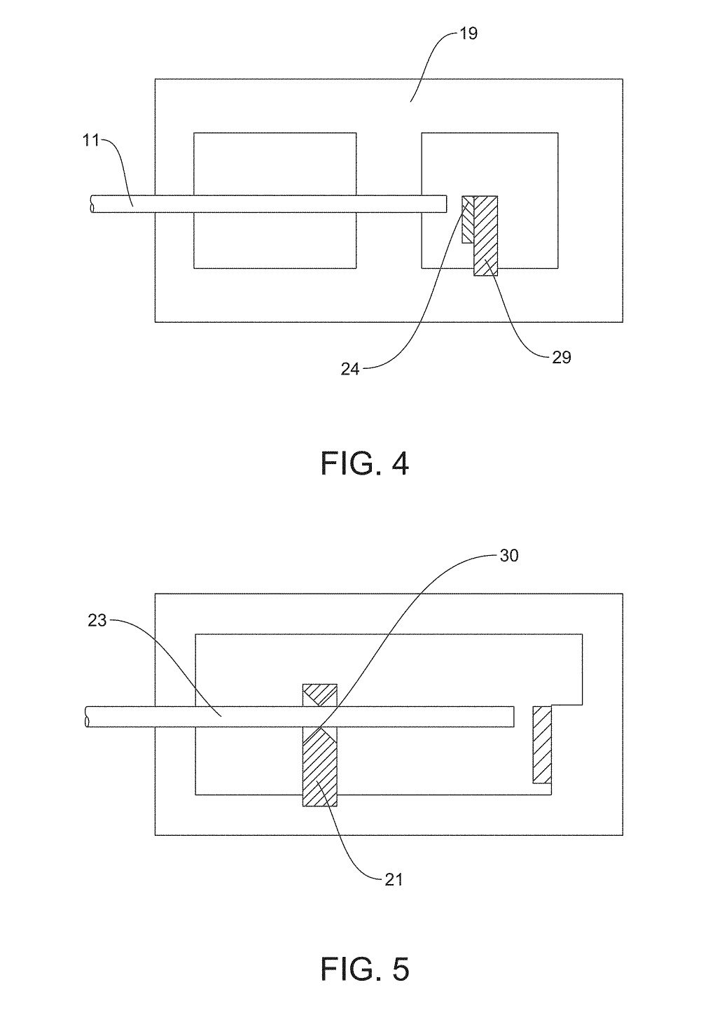

FIG. 4 show schematically a different construction of the fiber optic thermometer where the cantilever part of the fiber is absent. The internal part of the fiber 11 is rigidly fixed in the hollow body 19. The reflective target 24 is affixed to a support 29 made of material having high coefficient of thermal expansion. Under ambient temperature change the support 29 expands or shrinks and thus changes the position of the reflective target 24 relative to the fiber second end 13. This means that the instantaneous intensity of the light conveyed by the free end of the optical fiber toward the target 24 is reduced or increased, as is the instantaneous intensity of the light reflected by the target 24 to the optical fiber. As a result, the intensity of light reaching the photo detector 18 changes according to the changes of the ambient temperature and the output signal of photo detector 18 changes as a function of the temperature variation.

FIG. 5 is a schematic partial cross-sectional view of a fiber optic thermometer according to yet another embodiment where, in order to reduce the measurement error associated with friction, the contact surface between the intermediate support 21 and the fiber 23 has the shape of a sharp edge 30.

It will be appreciated that various modifications can be made without departing from the scope of the invention. Thus, while in the embodiments shown in FIGS. 1 and 2, for example, the intermediate support 21 is provided with a bore through which the optical fiber passes, the invention also contemplates the use of an intermediate support upon which the fiber merely rests. Likewise, although in FIG. 1 the intermediate support is supported in the lower part of the body portion 19, it could also be supported in the upper part.

1. A fiber optic thermometer comprising:
a hollow body made of material of low thermal expansion,
an intermediate support made of material of high thermal expansion,
an optical fiber having a first end and a second end remote from the first end, said optical fiber being supported toward the second end inside the hollow body and affixed to intermediate support so as to form a cantilever section,
a fiber optic splitter coupled to the first end of the optical fiber,
a light source for directing light into the optical fiber via a first branch of the optical splitter,
a photo detector arranged for receiving light conveyed through the optical fiber via a second branch of the optical splitter and measuring an intensity of the received light, and
a reflective target disposed within and supported at a second end of the hollow body so as to be axially aligned with the second end of the optical fiber at room temperature whereby upon changes of the ambient temperature changes the height of the intermediate support and thus cantilever section moves such that its position relative to the reflective target changes thereby changing the instantaneous intensity of light reflected by the target into the second end of the optical fiber and measured by the photo detector.

2. The fiber optic thermometer as claimed in claim 1, wherein a point of fixation of the intermediate support in the hollow body is adjustable thereby allowing adjustment of the length of the cantilever section and thus to change the sensitivity and dynamic range of the thermometer.

3. The fiber optic thermometer as claimed in claim 1, wherein the intermediate support includes a filament formed of a material having high thermal coefficient of expansion.

4. The fiber optic thermometer as claimed in claim 3, wherein the cantilever part of the fiber inside hollow body is bent in advance.

5. The fiber optic thermometer as claimed in claim 1, wherein free end of the optical fiber rigidly fixed inside hollow body and the reflective target is affixed to the support formed of a material having high coefficient of thermal expansion.

6. The fiber optic thermometer as claimed in claim 1, wherein the part of the intermediate support contacting with the optical fiber has a shape of a sharp edge.
